(19) United States
(12) Patent Application Publication
(10) Pub. No.: US 2024/0399378 A1
(43) Pub. Date: Dec. 5, 2024

(54) SYSTEM FOR MICROTOMY LABORATORY WITH SINGLE CONTROLLER

(71) Applicant: Leica Biosystems Nussloch GmbH, Nussloch (DE)

(72) Inventors: Tao WANG, Shanghai (CN); XiaoLiang TIAN, Shanghai (CN)

(21) Appl. No.: 18/797,806

(22) Filed: Aug. 8, 2024

Related U.S. Application Data
(63) Continuation of application No. PCT/CN22/77466, filed on Feb. 23, 2022.

(51) Int. Cl. B01L 7/02

(52) U.S. Cl. CPC B01L 7/02; B01L 2300/023; B01L 2300/0663; B01L 2300/0809; B01L 2300/1827

(57) ABSTRACT

A system includes a first base, a second base, a cable, and a control portion. The first base has a first heating element configured to heat a first functional component to increase the temperature of a fluid within the first functional component. The second base has a second heating element configured to heat a second functional component to dry one or more specimen slides. The cable couples the first base to the second base. The control portion is in communication with both the first heating element and the second heating element to control the first heating element and the second heating element simultaneously.

### PRIORITY

This application is a continuation of International Application No. PCT/CN2022/077466, entitled “System for Microtomy Laboratory with Single Controller,” filed on Feb. 23, 2022, the disclosure of which is incorporated by reference herein.

### BACKGROUND

Microtomes are devices that are configured to provide thin sections of material in a controlled manner. Such sections produced by a microtome may be subsequently transilluminated for analysis purposes as a part of a histology process. Specifically, analysis of such sections may be used in pathology labs for the analysis of tissue samples. In some circumstances, the thickness of such sections may be between about 0.1 to 100 μm. The utilization of a microtome may be referred to as “microtomy” in some circumstances.

In microtomy for analysis of tissue samples specifically, one or more tissue samples may first be embedded in paraffin wax prior to sectioning using a microtome. Such embedding processes may be used to provide structural stability to the tissue samples for subsequent manipulation during sectioning. Embedding may include various accessory items such as wax baths, cryogenic plates, etc. The embedded tissue samples may then be sectioned using a microtome to generate a plurality of prepared sections with each section including a combination of tissue and paraffin wax in a single thin film.

In some circumstances, microtomes may be used with certain accessory devices to aid in processing prepared sections. For instance, one example of processing may include transferring each prepared section onto a specimen slide. While several methods may be used for such transfer, one example includes the use of a water bath. In such uses, the prepared section may float on the surface of the water bath, thereby spreading the prepared section in a flat configuration. A technician may then manipulate a specimen slide beneath the prepared section to “scoop” or otherwise transfer the prepared specimen from the water bath and onto the specimen slide. Examples of some such water baths are described in U.S. Pat. No. 8,642,930, entitled “Device for Heating an Object by Means of Water Bath,” issued on Feb. 4, 2014.

After a prepared section is transferred to a specimen slide, it may be desirable to dry the specimen slide including the prepared section. For instance, in the example of water bath transfer described above, at least some water may remain either on the specimen slide itself or between the prepared section and the specimen slide. The presence of such water may lead to imaging artifacts or unnecessary slippage of the prepared section. Thus, it may be desirable in some circumstances to dry the specimen slide including the prepared section. In some examples, drying may be facilitated by a heated slide rack or oven.

While several medical instruments, systems, and methods have been made and used, it is believed that no one prior to the inventors has made or used the invention described in the appended claims.

### BRIEF DESCRIPTION OF THE DRAWINGS

The disclosed aspects will hereinafter be described in conjunction with the appended drawings, provided to illustrate and not to limit the disclosed aspects, wherein like designations denote like elements.

FIG. 1 depicts a perspective view of an example of a base for use in microtomy with certain accessory components.

FIG. 2 depicts an exploded perspective view of the base of FIG. 1 used with an example of a slide dryer.

FIG. 3 depicts a perspective view of the base of FIG. 1, with the slide dryer of FIG. 2 inserted into the base.

FIG. 4 depicts a side schematic view of a floor of the base of FIG. 1.

FIG. 5 depicts a side elevational view of an example of another slide dryer for use with the base of FIG. 1.

FIG. 6 depicts a side elevational view of another example of a slide dryer for use with the base of FIG. 1.

FIG. 7 depicts an exploded perspective view of the base of FIG. 1 used with an example of a water bath.

FIG. 8 depicts a perspective view of the base of FIG. 1, with the water bath of FIG. 7 inserted into the base.

FIG. 9 depicts an exploded perspective view of the base of FIG. 1 used with an example of a slide oven.

FIG. 10 depicts a perspective view of the base of FIG. 1, with the slide oven of FIG. 9 inserted into the base.

FIG. 11 depicts a top schematic view of an example configuration of multiple bases of FIG. 1 used to support use of multiple accessory components.

FIG. 12 depicts a top schematic view of another example configuration of multiple bases of FIG. 1 used to support use of multiple accessory components.

FIG. 13 depicts a top schematic view of yet another example configuration of multiple bases of FIG. 1 used to support use of multiple accessory components.

FIG. 14 depicts a side elevational view of multiple bases of FIG. 1 used together.

FIG. 15 depicts a top perspective view of a bath base.

FIG. 16 depicts a bottom plan view of the water bath base of FIG. 15.

FIG. 17 depicts a perspective view of cable for use with the water bath base of FIG. 15.

FIG. 18 depicts a top perspective view of a slide dryer base.

FIG. 19 depicts a bottom plan view of the slide dryer base of FIG. 18.

FIG. 20 depicts a bottom plan view of the water bath base of FIG. 15 in use with the slide dryer base of FIG. 18.

FIG. 21 depicts a top schematic view of an example configuration of the water bath base of FIG. 15 with the slide dryer base of FIG. 18.

### DETAILED DESCRIPTION

### I. Overview of Example Universal Accessory Base

Aspects of the present disclosure may be integrated into a specimen preparation and analysis system capable of performing a variety of biological sample preparation and analysis procedures (e.g., histology). Although aspects of the present disclosure are described herein in the context of microtomy, it should be understood that in some circumstances such aspects may be used in other contexts. For instance, other suitable contexts may include tissue grossing, embedding, staining, etc.

Various examples will be described below in conjunction with the drawings for purposes of illustration. It should be appreciated that many other implementations of the disclosed concepts are possible, and various advantages can be achieved with the disclosed implementations. Headings are included herein for reference and to aid in locating various sections. These headings are not intended to limit the scope of the concepts described with respect thereto. Such concepts may have applicability throughout the entire specification.

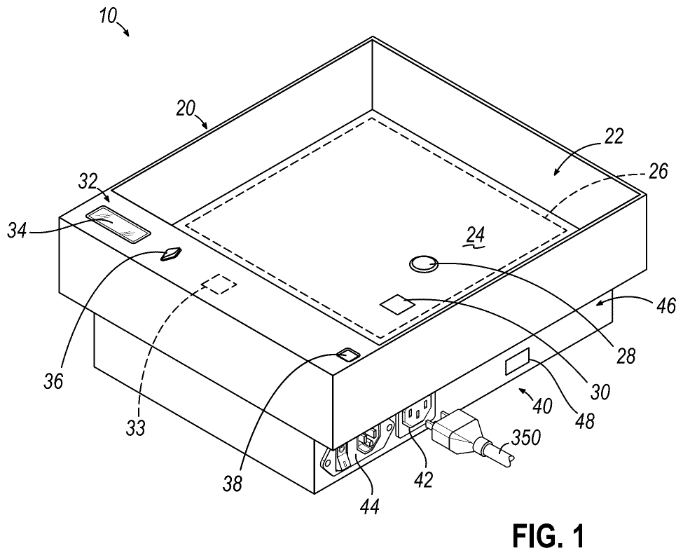

FIG. 1 illustrates an example of a base (10) configured for use with certain accessory items used during microtomy. As will be described in greater detail below, base (10) of the present version is configured to receive various modular components to customize base (10) for a given function. For instance, base (10) may receive a slide rack module for the function of slide drying, a water bath module for the function of transferring prepared sections to a specimen slide, and/or an oven module for the function of slide drying. Although base (10) is described herein as being usable with certain specific modules, it should be understood that in other versions, base (10) may be used with other modules adapted for other functions.

Base (10) is further configured for modular usage in connection with another base similar to base (10). Specifically, in some circumstances, it may be desirable to use multiple accessory items in a confined area or space such as the space near a microtome. However, the presence of multiple accessory items may consume such space unnecessarily due to the presence of separate power connections or irregular accessory item shapes and/or sizes. Thus, base (10) is generally configured to communicate with other bases (10) similar to base (10) to reduce power connections and the overall footprint the combination of base (10) and other bases (10).

Base (10) includes a receiving body (20) and a support platform (40) positioned beneath receiving body (20). Receiving body (20) includes a receiver (22) and a control portion (32) proximate receiver (22). Receiver (22) is configured as a square or rectangular-shaped recess extending downwardly into a portion of receiving body (20) and defining a floor (24). As will be described in greater detail below, floor (24) may be sloped or angled relative to the horizontal axis of base (10) to aid in fluid management.

Receiver (22) further includes a heating element (26), a pressure switch (28) (also referred to as an accessory sensor), and a temperature sensor (30). Each of heating element (26), pressure switch (28), and temperature sensor (30) may be positioned beneath floor (24), above floor (24), on top of floor (24), or integral with a portion of floor (24). Additionally, as will be described in greater detail below, each of heating element (26), pressure switch (28), and temperature sensor (30) may be in communication with a portion of control portion (32) to promote operation of base (10).

Heating element (26) is generally configured to heat the space defined by receiver (22). As will be described in greater detail below, receiver (22) may be used to receive various modular accessory components that may use heat. Thus, heating element (26) may be used to communicate heat from receiver (22) to various accessory components. Thus, in some versions, heating element (26) itself and/or portions of floor (24) may include a thermally conductive medium to facilitate the transfer of heat to other components.

Heating element (26) may include a variety of heat sources or combinations of heat sources. By way of example only, in some versions, heating element (26) may include one or more heat pads, one or more electrically resistive heating elements, etc. In the present version, heating element (26) corresponds to about the same area defined by floor (24) such that heat may radiate upwardly into receiver (22) from floor (24). In some versions, at least a portion of heating element (26) may also be incorporated into other portions of receiver (22) such as a sidewall to radiate heat horizontally or from other directions.

Pressure switch (28) is generally configured to detect the presence of an accessory component when the accessory component is seated or otherwise disposed within receiver (22). In the present version, pressure switch (28) is in communication with control portion (32) to turn off or break the circuit for heating element (26) when certain conditions are encountered. For instance, in some versions, pressure switch (28) itself or control circuitry associated with pressure switch (28) may be calibrated to turn off heating element (26) when limited or no pressure applied to floor (24) is detected. In other words, pressure switch (28) may be calibrated to detect the mass of an accessory component to permit operation of heating element (26) when an accessory component is seated or otherwise disposed within receiver (22). In the absence of an accessory component, pressure switch (28) may be in an open state to thereby break a circuit with heating element (26) to turn off heating element (26) when no accessory component is seated or otherwise disposed within receiver (22).

It should be understood that pressure switch (28) may include a variety of components having the functionality discussed above. For instance, in some versions pressure switch (28) may include a resiliently biased mechanism in communication with floor (24) to detect a predetermined force applied to floor (24). Such a resiliently biased mechanism may include, for example, a spring-loaded plunger that may be coupled to floor (24) or protrude from a portion of floor (24). The spring-loaded plunger may then be actuated by the mass of an accessory component either via floor (24) or direct engagement with the spring-loaded plunger. In other versions, the spring-loaded plunger may be recessed beneath floor (24) and accessory components may include a protrusion or other member configured to engage the spring-loaded plunger. On other versions, pressure switch (28) may include a variety of other sensors such as a hall effect sensor, a proximity sensor, an optical sensor, etc. Of course, in other versions, pressure switch (28) may have a variety of alternative configurations as will be apparent to those of ordinary skill in the art in view of the teachings herein.

Temperature sensor (30) is generally configured to detect the temperature near floor (24). Although temperature sensor (30) is illustrated in the present version at a single point, it should be understood that temperature sensor (30) may include a plurality of temperature sensors (30) linked in an array. Temperature sensor (30) may be in communication with control portion (32) to detect the temperature associated with receiver (22) in real-time for communication to an operator. As will be described in greater detail below, such real-time temperature measurements may be associated with modular accessory components received within receiver (22).

Control portion (32) includes a display (34), an input feature (36), and an indicator (38). Control portion (32) of the present example further includes a processor (33) and/or other control circuitry to support use of display (34), input feature (36), and indicator (38) in connection with heating element (26), pressure switch (28), and temperature sensor (30). For instance, input feature (36), pressure switch (28), and temperature sensor (30) may be in communication with processor (33) such that processor (33) may receive operational inputs from input feature (36), pressure switch (28), and temperature sensor (30) as described above. Processor (33) may also be in communication with heating element (26), display (34), and indicator (38) to drive heating element (26), display (34), and indicator (38) based on inputs received from input feature (36), pressure switch (28), and temperature sensor (30). Processor (33) may be used in some versions to provide a closed-loop feedback control algorithm to maintain a receiver (22) within a selected temperature range. Similarly, pressure switch (28) may be in communication with control circuitry to disrupt or alter such control algorithms. Display (34), input feature (36), and indicator (38) may likewise be in communication with control circuitry to provide operator control or operator feedback.

Display (34) is generally configured to provide feedback to an operator. In the present version, display (34) includes an LED display, OLED display, etc. Regardless, display (34) may be configured to present operational information to an operator such as the temperature detected by temperature sensor (30), menu options or other graphical user interfaces, timers, etc.

Input feature (36) is configured to permit user input. In the present version, input feature (36) includes two triangular buttons that may be used to adjust the temperature generated by heating element (26) up or down. In addition, or in the alternative, such buttons may be used to cycle through different predetermined modes, which may be depicted on display (34) as an operator cycles through said predetermined modes.

Indicator (38) is configured to provide certain operational status information to an operator. For instance, in the present version, indicator (38) includes a single or multi-colored LED that may illuminate differently to communicate an operational status to an operator. In some versions, indicator (38) may indicate that a certain temperature has been reached (e.g., a value set by an operator) by displaying one of a plurality of colors. In addition or in the alternative, in some versions, indicator (38) may indicate that a certain temperature has been reached by flashing or flickering at a certain frequency. In addition, or in the alternative, in some versions, indicator (38) may also indicate other operational statuses such as heating element (26) being active, but a predetermined temperature not yet achieved (e.g., pre-heating).

As described above, support platform (40) is disposed beneath receiving body (20). Support platform (40) is generally configured to provide support for receiving body (20), elevating receiving body (20) to a predetermined height. Additionally, support platform (40) is indented inwardly or recessed relative to receiving body (20) to define a recess (46) (also referred to as a groove, a channel, a passage, or a compartment) beneath a portion of receiving body (20). As will be described in greater detail below, recess (46) is generally configured to receive a power cable (350), multiple power cables (350), or other feature associated with operation of base (10) to store or contain such power cables (350) or other features.

In the present version, recess (46) extends around all sides of support platform (40). In other words, each dimension of support platform (40) is less than the corresponding dimension of receiving body (20) such that receiving body (20) defines an overhang, which defines a portion of recess (46). Although recess (46) extends around all sides of support platform (40) in the present version, it should be understood that in other versions, recess (46) may extend around only one side, 2 sides, or 3 sides of support platform (40).

As discussed above, recess (46) is configured to receive one or more power cables (350). It should therefore be understood that in some versions, recess (46) may include one or more cable management features (48) to promote storage of such cables (350) within recess (46). For instance, in some versions, such cable management features (48) may include one or more magnets that may be configured to attract metals or magnetic collars, or other features associated with each power cable (350). In such versions, the one or more magnets may pull or attached portions of each power cable (350) into specific portions of recess (46). In other versions, such cable management features (48) may include mechanical cable management features such as mechanical fasteners. Such fasteners may be used to secure or couple each power cable (350) to a particular portion of recess (46).

Support platform (40) further includes a power source interface that includes a power output (42) and a power input (44). As will be described in greater detail below, power output (42) and power input (44) are each generally configured to receive power cable (350) to communicate electric power to or from base (10). By way of example only, power output (42) and power input (44) may be configured to facilitate linking of each base (10) to a another base (10) similar to base (10). As will be described in greater detail below, this configuration may be desirable to link or chain several bases (10) similar to base (10) together with only a single power source being used to power all of such bases (10).

Although the present version is shown as having a separate and discrete power output (42) and power input (44), it should be understood that in other versions, power output (42) and power input (44) may be combined into a single port configured to communicate electric power either to or from base (10). In addition, or in the alternative, in some versions, power output (42) and/or power input (44) may be duplicated. For instance, in some versions, support platform (40) may include a power output (42) and/or a power input (44) on all or some sides of support platform (40) (e.g., right side and left side, front and back, etc.). In addition, or in the alternative, in some versions, power output (42) and/or power input (44) may be duplicated on a single side of support platform (40). For instance, in some versions, one or more sides of support platform (40) may include a single power input (44), but may include multiple power outputs (42) to support coupling of base (10) to a plurality of other bases similar to base (10). Of course, other suitable configurations of power output (42) and power input (44) will be apparent to those of ordinary skill in the art in view of the teachings herein.

### II. Example of Accessory Components for Base

In conventional accessory devices for microtomy, such devices may be specialized for a given purpose. For instance, conventional accessory devices may include a specialized slide dryer, a specialized slide oven, or a specialized water bath. However, such specialized accessory items may be inflexible under some circumstances because the function of each device may be limited to the specific function of a given accessory device. Thus, as described above, in some versions it may be desirable to allow base (10) to be used with various different kinds of accessory components to promote flexibility. In such versions, base (10) may function as a universal component configured to receive different accessory components on an as needed basis. In other words, a laboratory work space may be more easily reconfigured by switching accessory components in a given base (10) without having to move the base (10) itself. Several examples of accessory components that may be interchangeably used with base (10) will be described in greater detail below.

### A. Example of Slide Dryer Accessory Component

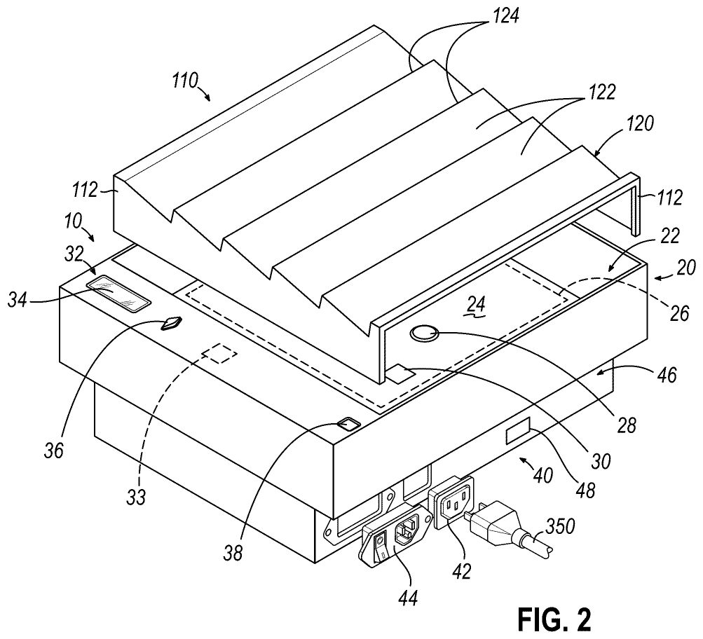

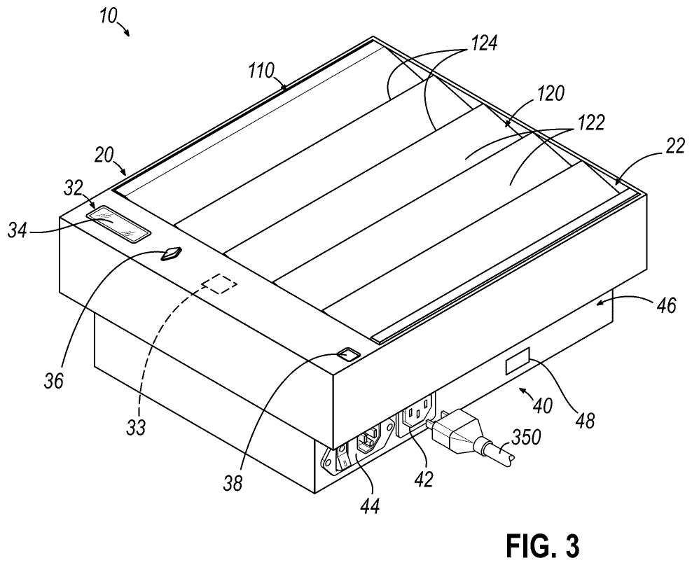

As best seen in FIGS. 2 and 3, base (10) may in some circumstances be used with a slide dryer (110) (also referred to as a slide rack, slide holder, or slide heater). Slide dryer (110) is generally configured to be received within receiver (22) of base (10) to receive heat from heating element (26) and dry specimen slides held on a surface of slide dryer (110). Slide dryer (110) includes a support body (112) (also referred to as body, support, or base portion) and a slide support (120) (also referred to as shelf, slide shelf, or holder). Support body (112) and slide support (120) are together configured to hold one or more specimen slides near heating element (26) to heat the held specimen slides to a desired temperature for the purpose of drying.

Support body (112) extends downwardly from slide support (120) and is configured to raise slide support (120) within receiver (22) to be approximately flush with the upper surface of base (10). Support body (112) is generally configured as two or more legs extending perpendicularly from each side of slide support (120). In other versions, support body (112) may include additional structural features such as cross-members to add additional structural rigidity to slide dryer (110). Although not shown, it should be understood that in some versions, support body (112) may additionally include a thermally conductive medium to promote the transfer of heat from heating element (26) to slide support (120). Furthermore, in some versions, support body (112) may additionally include a feature such as a protrusion configured to engage pressure switch (28) of base (10) when slide dryer (110) is fully seated in receiver (22) as described above.

Slide support (120) is generally configured to provide a surface on which to rest specimen slides for the purpose of drying. In the present version, slide support (120) is configured to hold a plurality of specimen slides at an angle relative to the horizontal axis of slide dryer (110). In particular, slide support (120) includes a plurality of angled slats (122) (also referred to as angled surfaces) configured to receive one or more specimen slides. Each angled slat (122) is connected to another angled slat (122) by a slide rest (124). Specifically, each slide rest (124) projects vertically, or at an angle, from one angled slat (122) to another. Each angled slat (122) is also oriented at an oblique angle relative to the horizontal axis of slide dryer (110) such that a specimen slide may be received on the surface of each angled slat (122) at an incline. Each slide rest (124) is thus configured to hold a specimen slide in position to prevent sliding of the specimen slide.

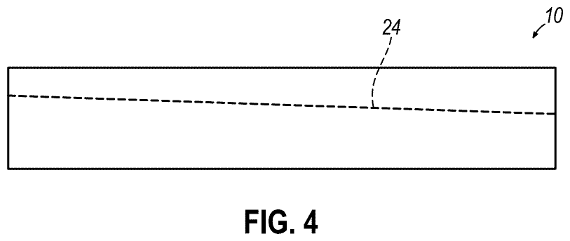

As described above, floor (24) of base (10) may be oriented at an angle relative to the horizontal axis of base (10). As best seen in FIGS. 3 and 4, this orientation of floor (24) may be configured to position slide dryer (110) at the same angle when received within receiver (22) of base (10). Thus, in addition to the angle described above with respect to angled slats (122), slide dryer (110) itself may also be positioned at an angle. Such a configuration may be desirable in some versions to promote the flow of fluid away from any specimen slides placed on slide dryer (110) and away from angled slats (122) to further promote drying of the specimen slides. Although not shown, it should be understood that in some versions, floor (24) may include a drain and/or fluid receptacle proximate the bottom of the slope of floor (24) to facilitate the management of fluid communicated from slide dryer (110).

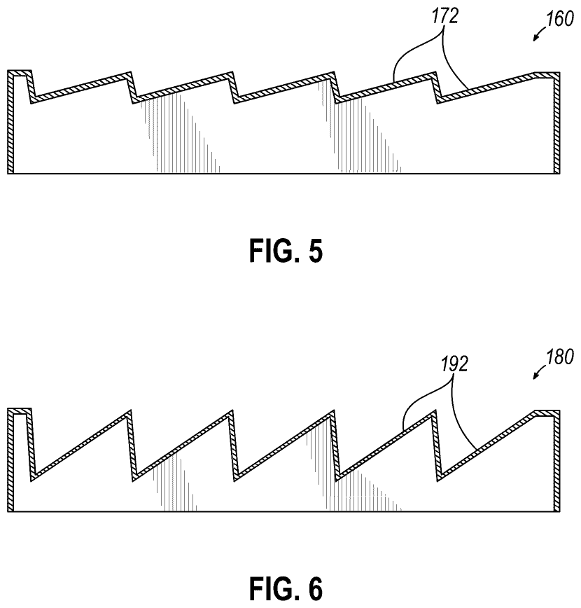

Although each angled slat (122) in the present version is shown as being oriented at a specific angle, it should be understood that in other versions, various alternative angles may be used. For instance, as best seen in FIGS. 5 and 6 in some versions two substantially similar slide dryers (160, 180) may be used interchangeably with base (10). In such versions, one slide dryer (160) may include angled slats (172) oriented at a relatively shallow angle (see FIG. 5) and another slide dryer (180) may include angled slats (192) oriented at a relatively steep angle (see FIG. 6). In addition, or in the alternative, in some versions a single slide dryer (110) may include angled slats (122) with one or more angled slats (122) oriented at different angles relative to another angled slat (122). Regardless of the particular configuration, the angle of each angled slat (122) is generally configured to promote the draining of fluid from a specimen slide during the slide drying process. In particular, the angle of each angled slat (122) may be configured to induce the drainage of fluid from one or more specimen slides via gravity to facilitate drying, while heat from heating element (26) may promote evaporation of fluids to further facilitate drying.

### B. Example of Water Bath Accessory Component

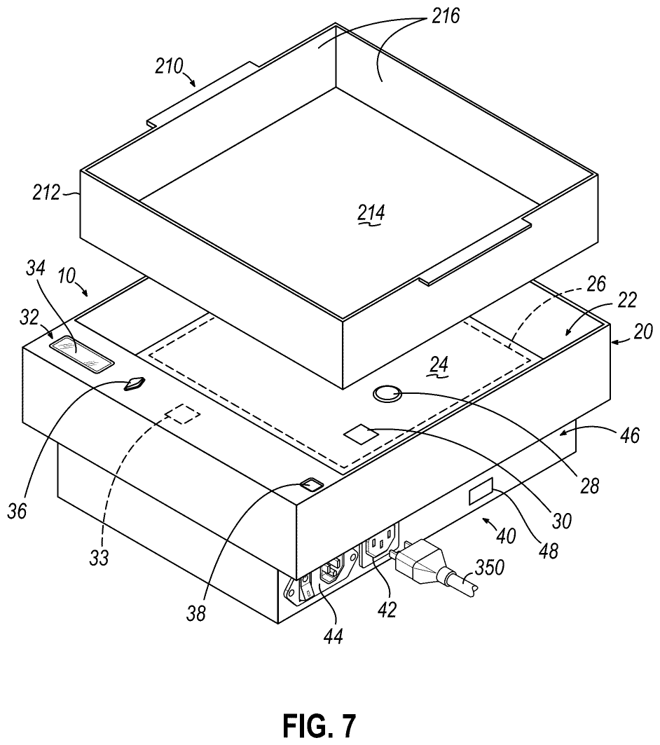

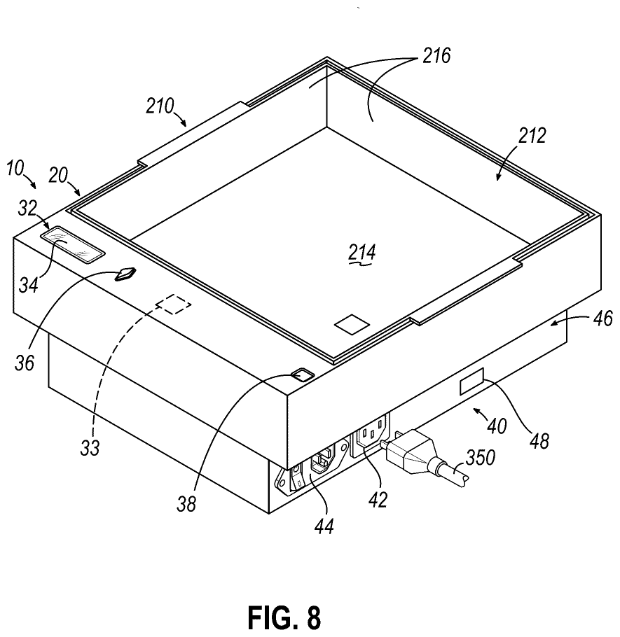

As best seen in FIGS. 7 and 8, base (10) may in some circumstances be used with a water bath (210) (also referred to as a floating bath, tissue bath, or liquid bath). Water bath (210) is generally configured to be received within receiver (22) of base (10) to receive heat from heating element (26) and to retain water within a portion of water bath (210). As described above, water bath (210) may be used in connection with a microtome to float prepared sections, which may aid in transferring the prepared sections to a specimen slide. Water bath (210) of the present version includes a support body (212) defining a water tank (220) (also referred to as a fluid tank, or fluid reservoir).

Support body (212) includes a floor (214) and a plurality of sidewalls (216) extending upwardly from floor (214). The size and shape of support body (212) approximately corresponds to the shape of receiver (22) of base (10). Thus, floor (214) in the present version is configured to abut floor (24) of receiver (22) when water bath (210) is received in base (10). Although not shown, it should be understood that in some versions, support body (212) may include a thermally conductive medium to promote the transfer of heat from heating element (26) to water tank (220). Such a thermally conductive medium may be separately attached to support body (212) or integrated into one or more components of support body (212) such as floor (214) or any one or more of sidewalls (216).

Floor (214) and sidewalls (216) together define water tank (220). Water tank (220) is generally configured to hold and contain fluid therein. Floor (214) and sidewalls (216) are therefore coupled together with fluid tight seals to prevent leakage of fluid from water tank (220). The particular size and shape of water tank (220) in the present version generally corresponds to the particular size and shape of receiver (22). Thus, water tank (220) is generally rectangular or square-shaped in the present version. However, it should be understood that in other versions, water tank (220) may be various alternative shapes such as round, oval-shaped, etc. In addition, or in the alternative, while the shape of water tank (220) in the present version corresponds to the shape of receiver (22), such correspondence in shape need not necessarily be used in other versions. For instance, in some versions, retainer (22) may be rectangular or square-shaped, while water tank (220) may be round.

As best seen in FIG. 8, water bath (210) is generally configured to fit into receiver (22) with an upper open area of water bath (210) approximately flush with the upper surface of base (10). Additionally, water bath (210) may be configured to engage pressure switch (28) when fully seated within receiver (22). Although not shown, it should be understood that water bath (210) may include one or more protrusions configured to engage pressure switch (28). Sidewalls (216) may thus correspond to about the depth of receiver (22). Additionally, in versions where floor (24) of receiver (22) is angled, floor (214) of water tank (220) may likewise be angled. Furthermore, to permit such an angled floor (214), sidewalls (216) may be tapered to permit the flush configuration described above.

### C. Example of Slide Oven Accessory Component

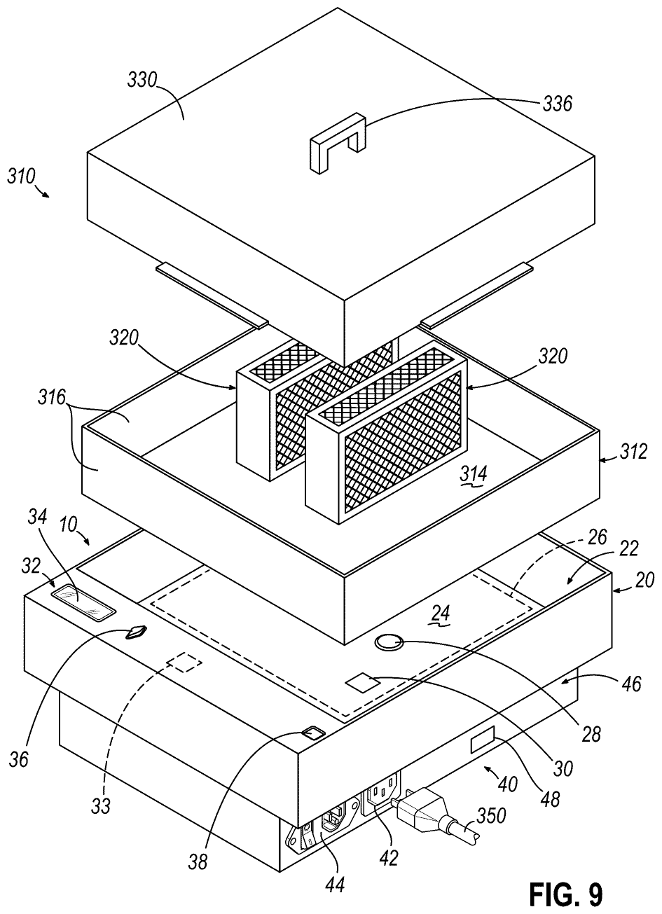

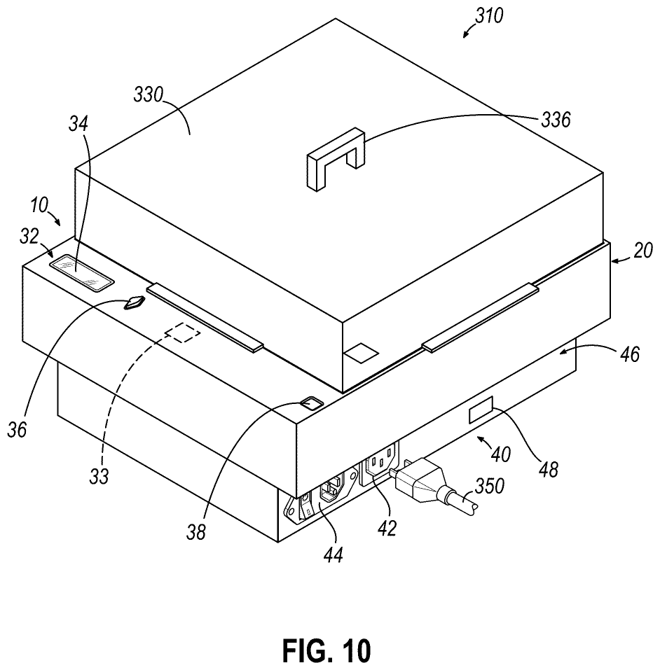

As best seen in FIGS. 9 and 10, base (10) may in some circumstances be used with a slide oven (310) (also referred to as a slide rack oven, enclosed slide heater, or oven). Slide oven (310) is generally configured to be received within receiver (22) of base (10) to receive heat from heating element (26) and dry specimen slides held within an interior of slide oven (310). Slide oven (310) includes a support body (312) (also referred to as body, support, or base portion), one or more slide containers (320) (also referred to as rack container, slide shelf, or holder), and a cap (330) (also referred to as a lid). Support body (312) and cap (330) are together configured to enclose one or more specimen slides held within slide containers (320) for heating using heating element (26) for the purpose of drying.

Support body (312) is configured for receipt within receiver (22), and to contain slide containers (320) and at least a portion of cap (330). Support body (312) includes a floor (314) and a plurality of sidewalls (316) extending upwardly from floor (314). Floor (314) and sidewalls (316) together define a generally rectangular or square-shaped configuration with an open upper portion for receipt of slide containers (320) and at least a portion of cap (330) within the interior of support body. Although not shown, it should be understood that in some versions, support body (312) may additionally include a thermally conductive medium to promote the transfer of heat from heating element (26) to each slide container (320). Such a thermally conductive medium may be separately attached to support body (312) or integrated into one or more components of support body (312) such as floor (314) or any one or more of sidewalls (316). In addition, although not shown, it should be understood that support body (312) may be configured to engage pressure switch (28) either directly with one or more protrusions or indirectly via engagement with floor (24).

Each slide container (320) is configured to receive one or more specimen slides for drying of the specimen slides. Each slide container (320) in the present version has a generally rectangular configuration and may include a plurality of slots for receiving one or more specimen slides therein. Although not shown, it should be understood that each slide container (320) may receive specimen slides in a variety of orientations such as horizontal, vertical, or angled. Additionally, although the present version is shown as including two slide containers (320), it should be understood that in other versions, any suitable number of slide containers (320) may be used such as one, three, or four.

Cap (330) is generally configured to nest within support body (312) to enclose slide containers (320) between cap (330) and support body (312). In other words, cap (330) may be configured to seal support body (312) to enhance thermal insulation and improve heating/drying efficiency. Cap (330) includes a top (332) and a plurality of sidewalls (334) in a similar, but opposite, configuration relative to floor (314) and sidewalls (316) described above. To facilitate manipulation of cap (330) by an operator, top (332) includes a grip (336). Although not shown, it should be understood that in some versions, at least a portion of cap (330) may be transparent to facilitate viewing of slide containers (320) during heating.

### III. Example Use of Multiple Bases

As described above, it may be desirable to use multiple bases (10) to more efficiently utilize space and to enhance flexibility. For instance, multiple bases (10) may be positioned closely together with only a single power source powering all bases (10). This configuration may reduce the total space required by reducing the space between each base (10) and also reducing the space that might be required for additional cabling extending from each base (10) to an independent power source. Additionally, flexibility may be improved by permitting the functionality of a given base (10) to change without moving the base itself (10) by substituting one accessory component (110, 210, 310) for another accessory component (310, 210, 110). While several example configurations are described below, it should be understood that various alternative configurations may be used without departing from the operational principles described herein.

FIG. 11 illustrates one example configuration using multiple bases (10). As can be seen, the present configuration includes four bases (10) linked together and powered by a single power source. Specifically, bases (10) are arranged in a square grid pattern with little or no space between each base (10). This spacing maximizes use of space by utilizing each recess (46) for threading of each power cable (350).

Each power cable (350) connects to a given base (10) so that only a single power source is used to power all four bases (10). In other words, bases (10) may be daisy chained together using power cables (350). For instance, one power cable (350) extends from the power source to a power input (44) of a first base (10). Another power cable (350) then extends from a power output (42) of the first base (10) to a power input (44) of a second base (10). Another power cable (350) extends from a power output (42) of the second base (10) to a power input (44) of a third base (10). Finally, another power cable (350) extends from a power output (42) of the second base (10) to a power input (44) of a fourth base (10). Although only four bases (10) are connected using power cables (350) in the present configuration, it should be understood that the same pattern may be repeated to use as many bases (10) as desired.

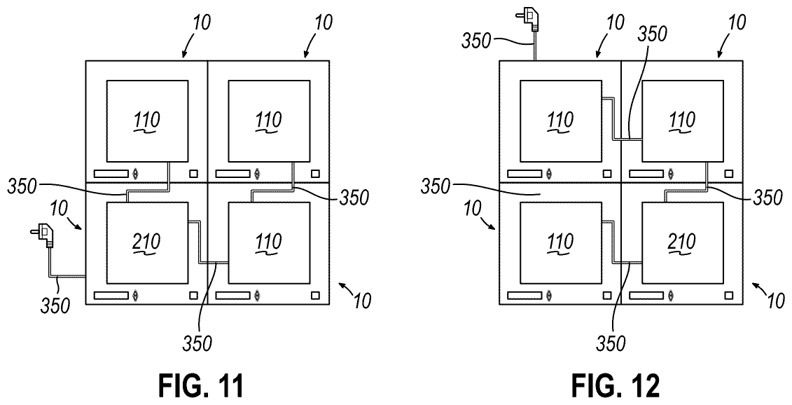

Functionality for each base (10) is facilitated by varying accessory components (110, 210, 310) being used with each base (10) of the configuration illustrated in FIG. 11. Specifically, in the present configuration, one base (10) receives water bath (210) as an accessory component, while three other bases (10) receive a separate slide dryer (110) as an accessory component. This configuration results in slide dryers (110) being in an L-shaped pattern with water bath (210) at one corner (e.g., the left corner). In use, this configuration may be desirable for a right-handed operator when the configuration illustrated in FIG. 11 is positioned to the left of a microtome because water bath (210) may be positioned closer to the operator's dominant hand. As illustrated in FIG. 12, this same configuration may be reversed or mirrored for use with a left-handed operator.

The configurations illustrated in FIGS. 11 and 12 also include varying power cable (350) arrangements. Thus, it should be understood that use of a plurality of bases (10) together may promote flexible power cable (350) arrangements. For instance, as illustrated in FIG. 11, in some configurations, one power cable (350) for communication with a power source may extend from one side of the configuration (e.g., the left side). In other configurations, as illustrated in FIG. 12, the power cable (350) for communication with the power source may extend from another side of the configuration (e.g., the rear side). It should therefore be understood that each base (10) provides flexibility so that the particular power cable (350) used to communicate with the power source may extend from any suitable side of the arrangement of bases (10). Such functionality may be desirable to suite the particular power cable (350) arrangement for a given laboratory environment.

Although the configurations illustrated in FIGS. 11 and 12 illustrate use of a single water bath (210) and three slide dryers (110), it should be understood that in other configurations, different combinations of accessory components (110, 210, 310) may be used. For instance, one or more of slide dryers (110) may be substituted for slide oven (310). In addition, or in the alternative, one or more slide dryers (110) may be substituted for water bath (210) to provide a configuration with more than one water bath (210).

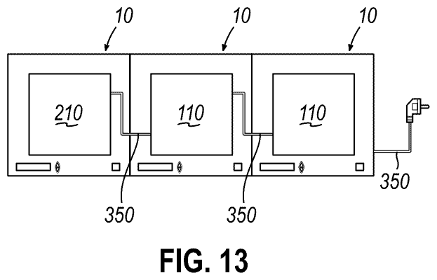

FIG. 13 illustrates another configuration for use of multiple bases (10) linked together. As can be seen, the present configuration includes three bases (10) linked together and powered by a single power source. Specifically, bases (10) are arranged linearly or in a line-based pattern with little or no space between each base (10). As described above, this spacing maximizes use of space by utilizing each recess (46) for threading of each power cable (350).

As with the configuration described above with respect to FIGS. 11 and 12, the configuration shown in FIG. 13 includes a power cable (350) coupled to a single power source and a plurality of power cables (350) coupling each base (10) to another base (10). Specifically, one power cable (350) extends from the power source to a power input (44) of a first base (10). Another power cable (350) then extends from a power output (42) of the first base (10) to a power input (44) of a second base (10). Another power cable (350) extends from a power output (42) of the second base (10) to a power input (44) of a third base (10). Although only three bases (10) are connected using power cables (350) in the present configuration, it should be understood that the same pattern may be repeated to use as many bases (10) as desired.

As similarly described above, functionality for each base (10) is facilitated by varying accessory components (110, 210, 310) being used with each base (10) of the configuration illustrated in FIG. 13. Specifically, in the present configuration, one base (10) receives water bath (210) as an accessory component, while two other bases (10) receive a separate slide dryer (110) as an accessory component. This configuration results in slide dryers (110) being along an axis and off to one side of the configuration and water bath (210) on another side of the configuration (e.g., the left side). In use, this configuration may be desirable for a right-handed operator when the configuration illustrated in FIG. 13 is positioned to the left of a microtome because water bath (210) may be positioned closer to the operator's dominant hand. This same configuration may be reversed or mirrored for use with a left-handed operator by positing water bath (210) on the opposite side as the configuration illustrated in FIG. 13.

Although the configurations illustrated in FIG. 13 illustrate use of a single water bath (210) and two slide dryers (110), it should be understood that in other configurations, different combinations of accessory components (110, 210, 310) may be used. For instance, one or more of slide dryers (110) may be substituted for slide oven (310). In addition, or in the alternative, one or more slide dryers (110) may be substituted for water bath (210) to provide a configuration with more than one water bath (210).

Regardless of the particular configuration used for multiple bases (10), it should be understood that the functionality of each base (10) may be changed without the need to reposition each individual base (10). Instead, functionality may be changed by replacing one accessory component (110, 210, 310) for another accessory component (310, 210, 110). Thus, in use, bases (10) may be positioned initially in a generally desirable configuration such as the square configurations described above with respect to FIGS. 11 and 12 or the linear configurations described above with respect to FIG. 13. Once the generally desirable configuration is set, the particular function of each individual base (10) may be adjusted as needed to satisfy user preferences or operational needs. In addition, or in the alternative, different styles of accessory components (110, 210, 310) may be changed without substantially changing function. For instance, as described above, some versions of slide dryer (110) may include different slide support (120) configurations. Thus, one slide dryer (110) might be substituted for another different slide dryer such as slide dryers (160, 180) described above.

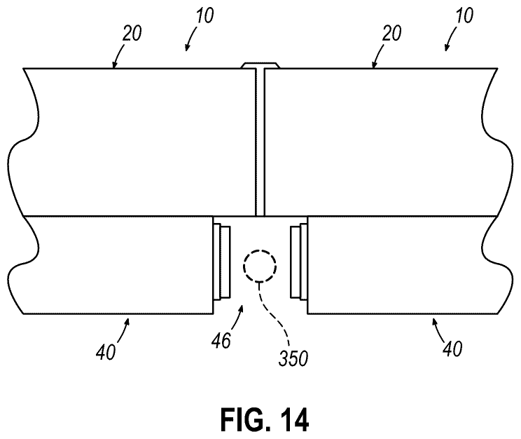

Regardless of the particular configuration or functionality of bases (10), bases (10) may generally be placed closely together to maximize use of space. FIG. 14 illustrates the placement of one base (10) relative to another base (10). As can be seen, each receiving body (20) may be positioned adjacent or near the other receiving body (20) to provide a generally continuous work surface between each base (10). Beneath each receiving body (20) the recess (46) of each base (10) provides a space though which a power cable (350) may be threaded or run. Thus, recess (46) of each base (10) permits any power cable (350) to be stowed or confined without requiring additional space between each base (10).

### IV. Examples of Alternative Accessory Bases

As described above, base (10) may generally be configured for use with certain accessory items to promote various functional uses of base (10). In the context of a system, multiple bases (10) may be used with different accessory items to provide flexible system configurations. However, in other versions, it may be desirable to dedicate the functionality of each base (10) to a particular function. In other words, it may be desirable for a system including separate bases with dedicated functions. Such dedicated bases may function as one or more of water baths, slide dryers, and/or slide ovens. Such dedicated bases may be desirable in some contexts to reduce product costs, improve case of manufacturability, and/or provide for more integrated control features. The following describes several examples of bases that may be used as bases that are dedicated to performing a certain corresponding function. However, some variations may provide more than one corresponding function for each of the bases described below. Thus, while the bases are described below in the context of being “dedicated,” it is contemplated that there may be some scenarios where the below-described bases are not necessarily “dedicated.”

### A. Example of Dedicated Water Bath Base

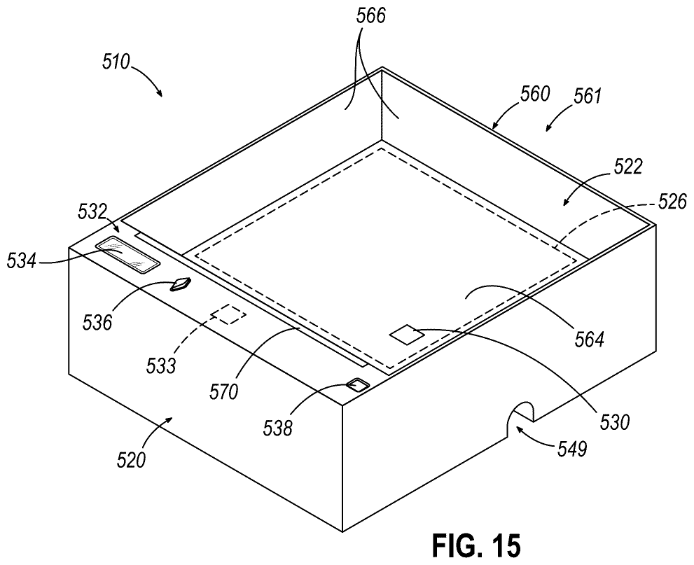

FIG. 15 shows a version of a dedicated water bath base (510). Water bath base (510) of the present version is generally similar to a combination of base (10) and water bath (210) described above. However, unlike the combination of base (10) and water bath (210), water bath base (510) of the present example is permanently configured to function as a water bath. Thus, water bath base (510) is configured with a single function that is not changeable like with base (10) described above. While water is used to provide a bath in the present example, any other suitable kind(s) of fluid(s) may be used to provide a bath, in addition to or in lieu of using water.

Like base (10) described above, water bath base (510) includes a body (520).

However, unlike body (20) described above, body (520) of the present example omits elements such as receiver (22) and floor (24). As will be described in greater detail below, certain water bath functional features may be integrated into body (520) such that elements such as receiver (22) and floor (24) are not strictly necessary. However, it should be understood that in other versions, water bath base (510) may include one or more removable components associated with such water bath functional features. As such, in some versions, body (520) may include elements similar to receiver (22) and floor (24) described above.

Although body (520) omits an element similar to receiver (22) in the present version, body (520) includes a heating element (526), a temperature sensor (530), and a control portion (532), similar to heating element (26), control portion (32) and sensor (30) described above. As with heating element (26) described above, heating element (526) of the present example is generally configured to heat a space defined by body (520). As will be described in greater detail below, body (520) may include certain water bath functional features that may be used in corporation with heating element (526) to heat fluids such as water, or other solutions.

As with heating element (26) described above, heating element (526) may include a variety of heat sources or combinations of heat sources. By way of example only, in some versions, heating element (526) may include one or more heat pads, one or more electrically resistive heating elements, etc. In the present version, heating element (526) corresponds to about the same area as the space defined by body (520) such that heat may radiate upwardly into the space defined by body (520). In some versions, at least a portion of heating element (526) may also be incorporated into other portions of body (520) such as a sidewall to radiate heat horizontally or from other directions.

Temperature sensor (530) is substantially similar to temperature sensor (30) described above. For instance, temperature sensor (530) is generally configured to detect the temperature within body (520). As will be described in greater detail below, this temperature detection feature of temperature sensor (530) may be used to detect the temperature associated with certain water bath functional features that may be used in corporation with heating element (526). Although temperature sensor (530) is illustrated in the present version at a single point, it should be understood that temperature sensor (530) may include a plurality of temperature sensors (530) linked in an array. Temperature sensor (530) may be in communication with control portion (532) to detect the temperature associated with the interior of body (520) in real-time for communication to an operator. As will be described in greater detail below, such real-time temperature measurements may be associated with certain water bath functional features disposed within body (520).

Control portion (532) includes a display (534), an input feature (536), and an indicator (538). Control portion (532) of the present version further includes a processor (533) and/or other control circuitry to support use of display (534), input feature (536), and indicator (538) in connection with heating element (526) and temperature sensor (530). For instance, input feature (536) and temperature sensor (530) may be in communication with processor (533) such that processor (533) may receive operational inputs from input feature (536) and temperature sensor (530) as described above. Processor (533) may also be in communication with heating element (526), display (534), and indicator (538) to drive heating element (526), display (534), and indicator (538) based on inputs received from input feature (536) and temperature sensor (530). Processor (533) may be used in some versions to provide a closed-loop feedback control algorithm to maintain a portion of body (520) within a selected temperature range. Display (534), input feature (536), and indicator (538) may likewise be in communication with control circuitry to provide operator control or operator feedback.

Display (534) of the present version is substantially similar to display (34) described above. For instance, display (534) is generally configured to provide feedback to an operator. In the present version, display (534) includes an LED display, OLED display, etc. Regardless, display (534) may be configured to present operational information to an operator such as the temperature detected by temperature sensor (530), menu options or other graphical user interfaces, timers, etc.

Input feature (536) of the present example may also be substantially similar to input feature (36) described above. For instance, input feature (536) of the present version is configured to permit user input. In the present version, input feature (536) includes two triangular buttons that may be used to adjust the temperature generated by heating element (526) up or down. In addition, or in the alternative, such buttons may be used to cycle through different predetermined modes, which may be depicted on display (534) as an operator cycles through said predetermined modes.

As with indicator (38) described above, indicator (538) in the present version is configured to provide certain operational status information to an operator. For instance, in the present version, indicator (538) includes a single or multi-colored LED that may illuminate differently to communicate an operational status to an operator. In some versions, indicator (538) may indicate that a certain temperature has been reached (e.g., a value set by an operator) by displaying one of a plurality of colors. In addition or in the alternative, in some versions, indicator (538) may indicate that a certain temperature has been reached by flashing or flickering at a certain frequency. In addition, or in the alternative, in some versions, indicator (538) may also indicate other operational statuses such as heating element (526) being active, but a predetermined temperature not yet achieved (e.g., pre-heating).

The interior of body (520) defines a functional area (561) that is configured to support a given function associated with base (510). In the present version, functional area (561) includes a water bath (560). Water bath (560) is configured similarly to water bath (210) described above. However, unlike water bath (210) described above, water bath (560) of the present version is integral with body (520) and is thus non-removable from body (520). Water bath (560) is generally configured to act as a fluid reservoir to hold water or other fluids suitable for floating prepared sections and aiding in the transference of such prepared sections onto one or more specimen slides.

Water bath (560) includes a water tank (562) defined by body (520). Water tank (562) includes a floor (564), and a plurality of sidewalls (566) extending upwardly from floor (564). Floor (564) in the present version is disposed above and/or proximate heating element (526) such that heat may radiate upwardly from heating element (526) and into the space defined by water tank (562). Similarly, floor (564) in the present version is disposed above and/or proximate temperature sensor (530) such that the temperature of fluid within water tank (562) may be measured using temperature sensor (530). Although not shown, it should be understood that in some versions, body (520) may include a thermally conductive medium to promote the transfer of heat from heating element (526) and into water tank (562).

Floor (564) and sidewalls (566) together define water tank (562). Water tank (562) is generally configured to hold an contain fluid therein. Floor (564) and sidewalls (566) are therefore coupled together with fluid tight seals to prevent leakage of fluid from water tank (562). The particular shape of water tank (562) in the present version is generally rectangular or square-shaped. However, it should be understood that in other versions, water tank (562) may be various alternative shapes such as round, oval-shaped, etc.

The top of water tank (562) is generally flush with the top of body (520). Thus, the level of fluid disposed within water tank (562) may align with the top of body (520) in some configurations. To facilitate visualization of the surface of fluid disposed within water tank (562), a illumination source (570) is included within body (520). Illumination source (570) in the present version includes an elongate light bar extending about the length of one or more sidewalls (566). In the present version, illumination source (570) is associated with control portion (532). Although in other versions, illumination source (570) may be associated with any one or more sides of body (520).

Illumination source (570) is generally configured to direct light onto the surface of fluid disposed within water tank (562). Illumination source (570) is configured to emit a generally planar beam of light at an angle into the interior of water tank (562). Such a beam may be provided from a variety of sources. For instance, in some versions, illumination source (570) may include an LED light strip, one or more incandescent bulbs, one or more laser light sources, one or more neon light sources, and/or etc. Additionally, the particular light emitted may be of various colors such as while light, red, green, blue, and/or other suitable colors. Aside from illumination, such colors may be varied to provide an indicator to an operator related to the status of water tank (562).

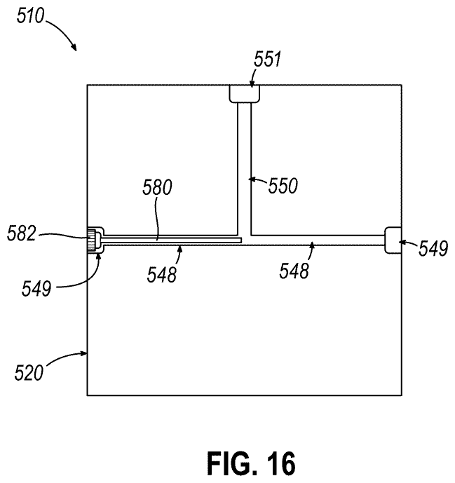

As best seen in FIG. 16, body (520) further defines a recess (546) associated with the bottom and/or sides of body (520). Recess (546) of the present version is similar to recess (46) described above in that recess (546) is generally configured for use in connection with cable management. To facilitate such cable management, recess (546) may include one or more fastening features similar to cable management feature (48) described above. However, unlike recess (46) described above, recess (546) of the present version is predominantly disposed with the bottom of body (520) rather than being an indentation, notch, or groove in the sides of body (520) like with recess (46) described above.

Recess (546) of the present version defines two side legs (548) and one rear leg (550) that intersect at approximately the center of body (520). Specifically, legs (548, 550) extend in different directions across the bottom of body (520) to provide a channel between the center of body (520) to one or more sides of body (520). As will be described in greater detail below, this configuration may be used to permit selective association of a cable (580) with a given side of body (520).

At the end of each leg (548, 550) opposite of the center of body (520), each leg (548, 550) includes a respective bore (549, 551) that is in communication with a given side of body (520). Each bore (549, 551) is oversized relative to the size of each leg (548, 550) to provide enhanced access to each respective leg (548, 550) at each side of body (520). As will be described in greater detail below, the presence of each bore (549, 551) may be used to facilitate use of cable (580) for coupling to other features associated with cable (580).

Cable (580) if the present version is approximately equivalent to the length of each leg (548, 550). In the present version, this length may be desirable to prevent excess length of cable (580) from being caught beneath body (520). It should be understood that cable (580) may be tethered to body (520) at the approximate center of body (520) where legs (548, 550) intersect. Cable (580) may thus be readily repositioned from one leg (548, 550) to another while being tethered at the center of body (520).

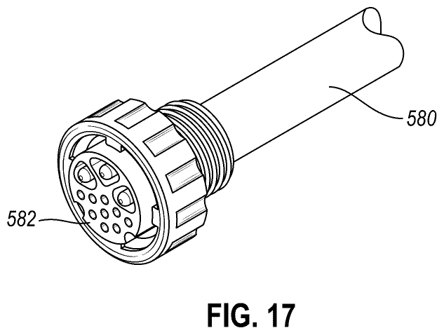

FIG. 17 shows cable (580) of the present version in greater detail. As can be seen, cable (580) includes a multi-function connector (582) having a diameter approximately corresponding to the size of each bore (548, 551). Multi-function connector (582) in the present version is configured to facilitate multiple communication functions with cable (580). For instance, cable (580) may be configured to supply power to base (510), communicate power from base (510), and communicate electrical inputs and/or outputs to and from base (510). Multi-function connector (582) may therefore include a plurality of pins, pin receivers, or other electrical coupling features to facilitate coupling of cable (580) to other similar cables. As will be described in greater detail below, this feature of multi-function connector (582) may be used to power base (510) itself, power other components, and also control other components using control portion (532) as a dedicated control portion (532) for all components.

### B. Example of Dedicated Slide Dryer Base

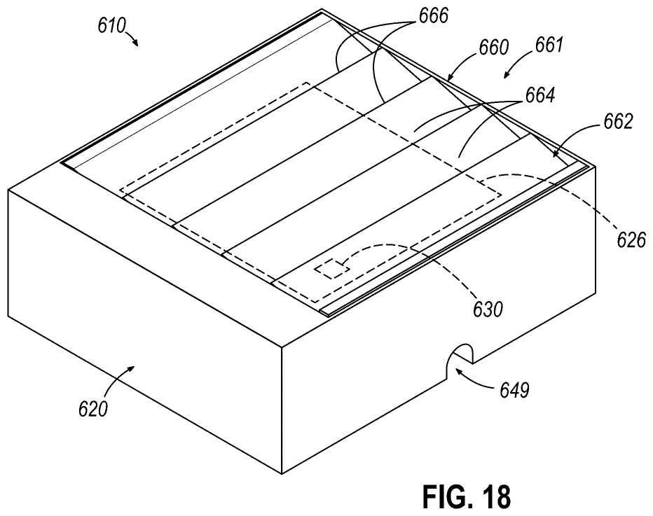

FIG. 18 shows a slide dryer base (610) that may be used in connection with water bath base (510) described above to provide an integrated system for preparing slides. Slide dryer base (610) includes a body (620) and functional area (661) disposed within a portion of body (620). Similarly to body (520) described above, body (620) of the present version includes a heating element (626) and a temperature sensor (630). However, unlike body (520) described above, body (620) of the present version omits elements similar to control portion (532) and related features. As will be described in greater detail below, heating element (626) and temperature sensor (630) are configured to be controlled by water bath base (510) via control portion (532). Elements similar to control portion (532) are therefore unnecessary in the present version of body (620). However, it should be understood that in some versions, body (620) may include elements similar to control portion (532) to provide auxiliary control for heating element (626) and temperature sensor (630).

Functional area (661) is defined by body (620) to facilitate a given functional feature associated with base (610). Although functional area (661) may take on a variety of forms (e.g., oven, water bath, etc.), in the present version, functional area (661) includes a slide dryer (660). Slide dryer (660) of slide dryer base (610) is similar to slide dryer (110) described above. However, unlike slide dryer (110), slide dryer (660) of the present version may be permanently fixed to slide dryer base (610). The functionality of slide dryer base (610) is thus dedicated to slide drying rather than other functions described above.

As with slide dryer (110) described above, slide dryer (660) of the present version includes a slide support (662) that is generally configured to be approximately flush with the top of body (620) to support one or more slides on the surface of slide support (662). Slide support (662) includes a plurality of angled slats (664) configured to receive one or more specimen slides. Each angled slat (664) is connected to another angled slat (664) by a slide rest (666). Specifically, each slide rest (666) projects vertically, or at an angle, from one angled slat (664) to another. Each angled slat (664) is also oriented at an oblique angle relative to the horizontal axis of slide dryer (660) such that a specimen slide may be received on the surface of each angled slat (664) at an incline. Each slide rest (666) is thus configured to hold specimen slide in position to prevent sliding of the specimen slide.

As noted above with respect to slide dryer (110), in some examples slide dryer (660) itself may be oriented at an angle relative to the plane of the top surface of body (620). Such an angled orientation may be in addition to the angle described above with respect to angled slats (664). In some versions, this angled configuration may be desirable to promote the flow of fluid away from specimen slides placed on slide dryer (660) and away from angled slats (664) to further promote drying of specimen slides.

Although each angled slat (664) in the present version is shown as being oriented at a specific angle, it should be understood that in other versions, various alternative angles may be used. For instance, any one or more of the angles described above with respect to slide dryers (160, 180) may be used in alternative to the angle shown in FIG. 18.

As noted above, slide dryer base (610) includes heating element (626) and temperature sensor (630). Heating element (626) may be positioned beneath and/or adjacent to slide dryer (660) to radiate heat upwardly into angled slats (664) to heat one or more specimen slides and facilitate drying of the one or more specimen slides. Similarly, temperature sensor (630) may also be positioned beneath and/or adjacent to slide dryer (660) to facilitate control of heating element (626). In the present version, this configuration of temperature sensor (630) may be used to control the temperature of slide dryer (660) within a predetermined range as determined by control portion (532) of water bath base (510).

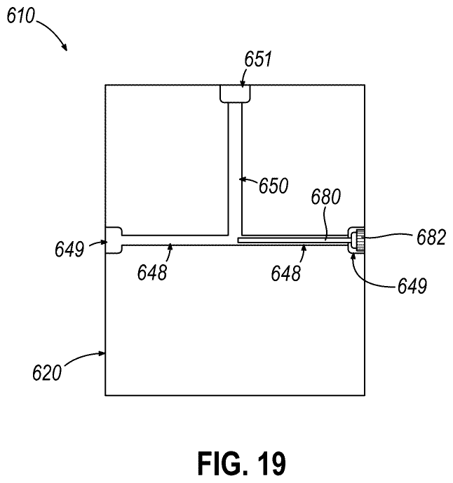

As best seen in FIG. 19, body (620) further defines a recess (646) associated with the bottom and/or sides of body (620). Recess (646) of the present version is similar to recess (46) described above in that recess (646) is generally configured for use in connection with cable management. To facilitate such cable management, recess (646) may include one or more fastening features similar to cable management feature (48) described above. However, unlike recess (46) described above, recess (646) of the present version is predominantly disposed within the bottom of body (620) rather than being an indentation, notch, or groove in the sides of body (620) like with recess (46) described above.

Recess (646) of the present version defines two side legs (648) and one rear leg (650) that intersect at approximately the center of body (620). Specifically, legs (648, 650) extend in different directions across the bottom of body (620) to provide a channel between the center of body (620) to one or more sides of body (620). As will be described in greater detail below, this configuration may be used to permit selective association of a cable (680) with a given side of body (620).

At the end of each leg (648, 650) opposite the center of body (620), each leg (648, 650) includes a respective bore (649, 651) that is in communication with a given side of body (620). Each bore (649, 651) is oversized relative to the size of each leg (648, 650) to provide enhanced access to each respective leg (648, 650) at each side of body (620). As will be described in greater detail below, the presence of each bore (649, 651) may be used to facilitate use of cable (680) for coupling to cable (580) of water bath base (510) described above.

Cable (680) is substantially similar to cable (580) described above. For instance, cable (680) of the present version defines a length that is approximately equivalent to the length of each leg (648, 650). This length may be desirable to prevent excess length of cable (680) from being caught beneath body (620). It should be understood that cable (680) may be tethered to body (620) at the approximate center of body (620) where legs (648, 650) intersect. Cable (680) may thus be readily repositioned from one leg (648, 650) to another while being tethered at the center of body (620).

As with cable (580) described above, cable (680) of the present version likewise includes a multi-function connector (682). Multi-function connector (682) of cable (680) is generally configured to couple with multi-function connector (582) of cable (580) to permit communication of power and/or data between water bath base (510) and slide dryer base (610). The size of multi-function connector (682) corresponds to the size of each bore (648, 651). Multi-function connector (682) may thus be received in each bore (648, 651).

Multi-function connector (682) of the present version is configured to facilitate multiple communication functions with cable (680). For instance, cable (680) may be configured to supply power to base (610), communicate power from base (610), and communicate electrical inputs and/or outputs to and from base (610). Multi-function connector (682) may therefore include a plurality of pins, pin receivers, or other electrical coupling features to facilitate coupling of cable (680) to other similar cables such as cable (580). As will be described in greater detail below, this feature of multi-function connector (682) may be used to power base (610) itself, power other components, receive power, and also facilitate control of base (610) via other components such as water bath base (510).

C. Example Use of Dedicated Water Bath Base and Slide Dryer Base in a System

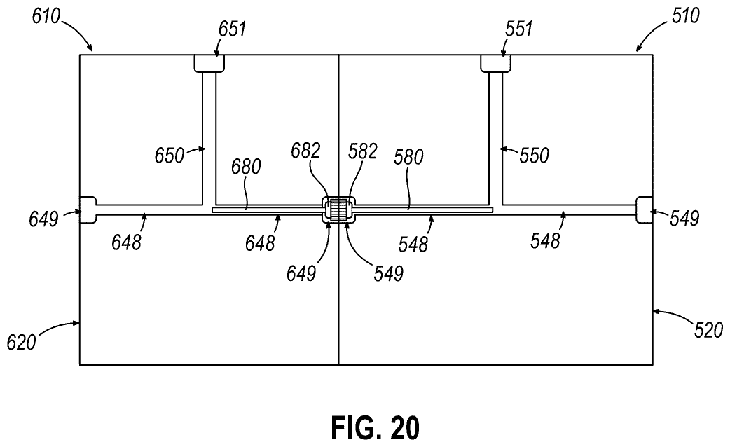

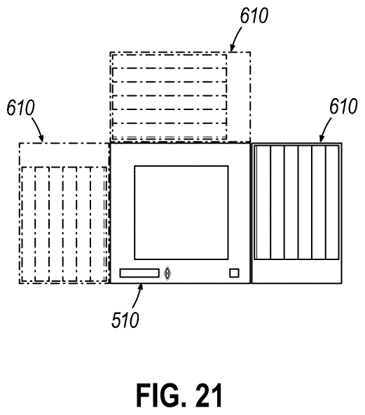

FIGS. 20 and 21 show an example of a use of water bath base (510) and slide dryer base (610) together in a system. As best seen in FIG. 20, water bath base (510) and slide dryer base (610) may be coupled together via multi-function connectors (582, 682) of each respective cable (580, 680). In the present version, water bath base (510) is configured to operate as a leader unit, which may permit operational control of both water bath base (510) and slide dryer base (610) using control portion (532). Slide dryer base (610) may accordingly operate as a follower unit, relying on water bath base (510) for functional control.

In the present version, water bath base (510) is configured to receive power and distribute power to slide dryer base (610). Power may be supplied to water bath base (510) via a variety of mechanisms. For instance, in some versions water bath base (510) may include a separate power cable configured to coupe to a wall outlet. In such versions, the separate power cable may be configured for use with recess (546) along with cable (580). Alternatively, the separate power cable may be separate from recess (546) and project from any side of body (520) such as the rear or either side. In yet other versions, cable (580) of water bath base (510) may include a split section that may be used to couple water bath base (510) to a power source such as a wall outlet. In still other versions, the power source may be integrated into water bath base (510) as a battery.

As can be seen in FIG. 21, water bath base (510) and slide dryer base (610) may be placed in a variety of positions relative to each other by threading each respective cable (580, 680) through each recess (546, 646). For instance, in one configuration, slide dryer base (610) may be positioned on either the left side or right side of water bath base (510) by threading cables (580, 680) through a given side leg (548, 648). In other configuration, slide dryer base (610) may be positioned on the rear side of water bath base (510) by threading cable (580) through rear leg (550) and cable (680) through a given side leg (648) or rear leg (660), depending on the orientation of slide dryer base (610).

Although not shown, it should be understood that in some versions, multiple slide dryer bases (610) may be used in connection with one water bath base (510). In such examples, water bath base (510) may include one or more additional cables (580) to support multiple coupling arrangements. In versions with multiple cables (580), one or more of such multiple cables (580) may be selectively detachable from water bath base (510) to support varying modes of operation. In addition, or in the alternative, each slide dryer base (610) may include one or more additional cables (680) to permit slide dryer base (610)-to-slide dryer base (610) coupling arrangements. Such additional cables (680) may likewise be selectively detachable to support varying modes of operation.

As with the configurations describe above with respect to FIG. 21, arrangements with multiple slide dryer bases (610) may take on a variety of configurations. For instance, in some configurations water bath base (510) may be placed centrally with a separate slide dryer base (610) on either side and/or the rear. In other configurations, water bath base (510) may be disposed on one side, with a plurality of slide dryer bases (610) arranged from a single side or the rear of water bath base (510).

### V. Examples of Combinations

The following examples relate to various non-exhaustive ways in which the teachings herein may be combined or applied. The following examples are not intended to restrict the coverage of any claims that may be presented at any time in this application or in subsequent filings of this application. No disclaimer is intended. The following examples are being provided for nothing more than merely illustrative purposes. It is contemplated that the various teachings herein may be arranged and applied in numerous other ways. It is also contemplated that some variations may omit certain features referred to in the below examples. Therefore, none of the aspects or features referred to below should be deemed critical unless otherwise explicitly indicated as such at a later date by the inventors or by a successor in interest to the inventors. If any claims are presented in this application or in subsequent filings related to this application that include additional features beyond those referred to below, those additional features shall not be presumed to have been added for any reason relating to patentability.

### Example 1

A system, comprising: a first base having a first heating element configured to heat a first functional component to increase the temperature of a fluid within the first functional component; a second base having a second heating element configured to heat a second functional component to dry one or more specimen slides; a cable coupling the first base to the second base; and a control portion in communication with both the first heating element and the second heating element to control the first heating element and the second heating element simultaneously.

### Example 2

The system of Example 1, the cable having a multi-function connector, the cable being configured to communicate a data signal and power via the multi-function connector.

### Example 3

The system of Examples 1 or 2, the control portion being incorporated into a portion of the first base, the control portion being in communication with the second base via the cable.

### Example 4

The system of any one or more of Examples 1 through 3, the cable being a first cable extending from a portion of the first base, the system further comprising a second cable extending from a portion of the second base, the first cable and second cable each including a respective multi-function connector configured to couple the first cable with the second cable.

### Example 5

The system of any one or more of Examples 1 through 4, the first base defining a recess extending beneath a bottom portion of the first base, the recess being configured to receive the cable within a portion of the recess.

### Example 6

The system of Example 5, the first base including one or more fastening features associated with the recess, the one or more fastening features being configured to retain the cable within a portion of the recess.

### Example 7

The system of Examples 5 or 6, the recess including a first leg and a second leg, the first leg extending from a side of the first base across the bottom portion of the first base, the second leg extending from an opposite side of the first base across the bottom portion of the first base, the first leg and the second leg being configured to interact with each other.

### Example 8

The system of Examples 5 or 6, the recess including a pair of side legs and a rear leg, the side legs and rear leg forming an intersection, the pair of side legs and rear leg extending in opposite directions from the intersection towards a respective side of the first base.

### Example 9

The system of any one or more of Examples 1 through 8, the first base including a receiver, the receiver being configured to receive the first functional component, the first heating element being positioned proximate to the receiver to communicate heat to the first functional component.

### Example 10

The system of any one or more of Examples 1 through 9, the second functional component including a slide dryer, the slide dryer being configured to receive heat from the second heating element to heat one or more specimen slides positioned on the slide dryer.

### Example 11

The system of any one or more of Examples 1 through 9, the first functional component including a water bath, the water bath being configured to receive heat from the first heating element to warm fluid disposed within a portion of the water bath.

### Example 12

The system of Example 11, the first base including an elongate light bar, the elongate light bar being configured to direct light towards the water bath.

### Example 13

The system of any one or more of Examples 1 through 12, the first base including a first temperature sensor, the second base including a second temperature sensor, the first temperature sensor being proximate the first heating element, the second temperature sensor being proximate the second heating element.

### Example 14

The system of Example 13, the first temperature sensor being in communication with a processor of the control portion, the processor being configured to drive the first heating element based on temperature data from the first temperature sensor to maintain a first predetermined temperature using the first heating element and the first temperature sensor, the second temperature sensor being in communication with the processor of the control portion, the processor being further configured to drive the second heating element based on temperature data from the second temperature sensor to maintain a second predetermined temperature using the second heating element and the second temperature sensor.

### Example 15

The system of any one or more of Examples 1 through 14, the first functional component being permanently affixed to the first base, the second functional component being permanently affixed to the second base.

### Example 16

A system, comprising: a first base having a first heating element configured to heat a first accessory component to increase the temperature of a fluid within the first accessory component, the first base further including a control portion in communication with the first heating element; a second base having a second heating element configured to heat a second accessory component to dry one or more specimen slides; and a multi-function cable extending from the first base to the second base, the control portion of the first base being in the second heating element via the multi-function cable.

### Example 17

The system of Example 16, the first base defining a first recess, the second base defining a second recess, the multi-function cable extending through the first recess, the second recess, or both the first recess and the second recess.

### Example 18

The system of Examples 16 or 17, the first base having a first side, the second base having a second side, the first side being adjacent to the second side, the multi-function cable extending between the first side and the second side.

### Example 19

The system of any one or more of Examples 16 through 18, the first base including a power source interface, the power source interface being configured to communicate power from a power source to the first base and the second base.

### Example 20

An apparatus, comprising: a body including: a first heating element, a control portion, the control portion including a processor in communication with the first heating element and one or more user interface features, the one or more user interface features being in communication with the processor to control the first heating element via the processor, and a first functional area, the first functional area being configured to operate as a water bath or a slide dryer, the heating element being configured to heat a portion of the first functional area; and a multi-function cable extending from a portion of the body, the processor being in communication with a second heating element via the multi-function cable, the processor being configured to control the second heating element simultaneously with control of the first heating element.

### V. Miscellaneous

It should be noted that the terms “couple,” “coupling,” “coupled” or other variations of the word couple as used herein may indicate either an indirect connection or a direct connection. For example, if a first component is “coupled” to a second component, the first component may be either indirectly connected to the second component via another component or directly connected to the second component.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

As used herein, the term “plurality” denotes two or more. For example, a plurality of components indicates two or more components. The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

It should be understood that any of the versions of the devices or components described herein may include various other features in addition to or in lieu of those described above. By way of example only, any of the devices herein may also include one or more of the various features disclosed in any of the various references that are incorporated by reference herein. Various suitable ways in which such teachings may be combined will be apparent to those skilled in the art.

It should be understood that any one or more of the teachings, expressions, embodiments, examples, etc. described herein may be combined with any one or more of the other teachings, expressions, embodiments, examples, etc. that are described herein. The above-described teachings, expressions, embodiments, examples, etc. should therefore not be viewed in isolation relative to each other. Various suitable ways in which the teachings herein may be combined will be readily apparent to those skilled in the art in view of the teachings herein. Such modifications and variations are intended to be included within the scope of the claims.

It should be appreciated that any patent, publication, or other disclosure material, in whole or in part, that is said to be incorporated by reference herein is incorporated herein only to the extent that the incorporated material does not conflict with existing definitions or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions or other disclosure material set forth herein will only be incorporated to the extent that no conflict arises between that incorporated material and the existing disclosure material.

Having shown and described various embodiments of the present invention, further adaptations of the methods and systems described herein may be accomplished by appropriate modifications by one of ordinary skill in the art without departing from the scope of the present invention. Several of such potential modifications have been mentioned, and others will be apparent to those skilled in the art. For instance, the examples, embodiments, geometrics, materials, dimensions, ratios, steps, and the like discussed above are illustrative and are not required. Accordingly, the scope of the present invention should be considered in terms of the following claims and is understood not to be limited to the details of structure and operation shown and described in the specification and drawings.

1. A system, comprising:
(a) a first base having a first heating element configured to heat a first functional component to increase the temperature of a fluid within the first functional component;
(b) a second base having a second heating element configured to heat a second functional component to dry one or more specimen slides;
(c) a cable coupling the first base to the second base; and
(d) a control portion in communication with both the first heating element and the second heating element to control the first heating element and the second heating element simultaneously.

2. The system of claim 1, the cable having a multi-function connector, the cable being configured to communicate a data signal and power via the multi-function connector.

3. The system of claim 1, the control portion being incorporated into a portion of the first base, the control portion being in communication with the second base via the cable.

4. The system of claim 1, the cable being a first cable extending from a portion of the first base, the system further comprising a second cable extending from a portion of the second base, the first cable and second cable each including a respective multi-function connector configured to couple the first cable with the second cable.

5. The system of claim 1, the first base defining a recess extending beneath a bottom portion of the first base, the recess being configured to receive the cable within a portion of the recess.

6. The system of claim 5, the first base including one or more fastening features associated with the recess, the one or more fastening features being configured to retain the cable within a portion of the recess.

7. The system of claim 5, the recess including a first leg and a second leg, the first leg extending from a side of the first base across the bottom portion of the first base, the second leg extending from an opposite side of the first base across the bottom portion of the first base, the first leg and the second leg being configured to interact with each other.

8. The system of claim 5, the recess including a pair of side legs and a rear leg, the side legs and rear leg forming an intersection, the pair of side legs and rear leg extending in opposite directions from the intersection towards a respective side of the first base.

9. The system of claim 1, the first base including a receiver, the receiver being configured to receive the first functional component, the first heating element being positioned proximate to the receiver to communicate heat to the first functional component.

10. The system of claim 1, the second functional component including a slide dryer, the slide dryer being configured to receive heat from the second heating element to heat one or more specimen slides positioned on the slide dryer.

11. The system of claim 1, the first functional component including a water bath, the water bath being configured to receive heat from the first heating element to warm fluid disposed within a portion of the water bath.

12. The system of claim 11, the first base including an elongate light bar, the elongate light bar being configured to direct light towards the water bath.

13. The system of claim 1, the first base including a first temperature sensor, the second base including a second temperature sensor, the first temperature sensor being proximate the first heating element, the second temperature sensor being proximate the second heating element.

14. The system of claim 13, the first temperature sensor being in communication with a processor of the control portion, the processor being configured to drive the first heating element based on temperature data from the first temperature sensor to maintain a first predetermined temperature using the first heating element and the first temperature sensor, the second temperature sensor being in communication with the processor of the control portion, the processor being further configured to drive the second heating element based on temperature data from the second temperature sensor to maintain a second predetermined temperature using the second heating element and the second temperature sensor.

15. The system of claim 1, the first functional component being permanently affixed to the first base, the second functional component being permanently affixed to the second base.

16. A system, comprising:
(a) a first base having a first heating element configured to heat a first accessory component to increase the temperature of a fluid within the first accessory component, the first base further including a control portion in communication with the first heating element;
(b) a second base having a second heating element configured to heat a second accessory component to dry one or more specimen slides; and
(c) a multi-function cable extending from the first base to the second base, the control portion of the first base being in the second heating element via the multi-function cable.

17. The system of claim 16, the first base defining a first recess, the second base defining a second recess, the multi-function cable extending through the first recess, the second recess, or both the first recess and the second recess.

18. The system of claim 16, the first base having a first side, the second base having a second side, the first side being adjacent to the second side, the multi-function cable extending between the first side and the second side.

19. The system of claim 16, the first base including a power source interface, the power source interface being configured to communicate power from a power source to the first base and the second base.

20. An apparatus, comprising:
(a) a body including:
(i) a first heating element,
(ii) a control portion, the control portion including a processor in communication with the first heating element and one or more user interface features, the one or more user interface features being in communication with the processor to control the first heating element via the processor, and
(iii) a first functional area, the first functional area being configured to operate as a water bath or a slide dryer, the heating element being configured to heat a portion of the first functional area; and
(b) a multi-function cable extending from a portion of the body, the processor being in communication with a second heating element via the multi-function cable, the processor being configured to control the second heating element simultaneously with control of the first heating element.
